(19) United States
(12) Patent Application Publication
(10) Pub. No.: US 2015/0312453 A1
(43) Pub. Date: Oct. 29, 2015

(54) Switchable Camera Mirror Apparatus

(71) Applicant: Microsoft Technology Licensing, LLC, Redmond, WA (US)

(72) Inventors: David M. Gaines, Woodinville, WA (US); Andrew N. Cady, Kirkland, WA (US)

(21) Appl. No.: 14/792,154

(22) Filed: Jul. 6, 2015

Related U.S. Application Data
(62) Division of application No. 13/593,066, filed on Aug. 23, 2012.

(51) Int. Cl. H04N 5/225; G02B 5/08; G02B 26/08

(52) U.S. Cl. CPC H04N 5/2254; G02B 26/0816; G02B 5/08

(57) ABSTRACT

Techniques for switchable camera mirror apparatus are described. In one or more embodiments, a computing device (e.g., a tablet device, a smartphone, and so on) includes a camera functionality that is configured to capture images from a variety of different device perspectives. The camera functionality, for instance, can enable images to be captured from a front-facing device perspective, a rear-facing device perspective, and so on. Included as part of the camera functionality is a switchable mirror apparatus that is switchable to alternately reflect light from different device perspectives, such as to enable images to be captured from at least some of the different device perspectives using a single image sensor.

### RELATED APPLICATIONS

This application is a divisional of and claims priority under 35 U.S.C. §120 to U.S. patent application Ser. No. 13/593,066, filed on Aug. 23, 2012, titled “Switchable Camera Mirror Apparatus”, the disclosure of which is incorporated by reference herein in its entirety.

### BACKGROUND

Many computing devices include an integrated camera. Further, some computing devices include multiple cameras for capturing images from different perspectives. For example, a mobile phone may include a rear-facing camera for capturing images of objects facing a rear surface of the phone, and a front-facing camera for capturing images of objects facing a front surface of the phone.

While having the ability to capture images from multiple perspectives relative to a computing device can be useful, implementing multiple cameras in a single device involves a number of considerations. For example, a conventional multi-camera device typically includes a dedicated camera sensor for each capture perspective. A front-facing camera, for instance, may have its own camera sensor, and a rear-facing camera may utilize a different camera sensor Implementing a dedicated camera sensor for each capture perspective in a single device can reduce the amount of space available for other device components, which is particularly pertinent with the current emphasis on decreasing the size of portable devices. Further, each camera sensor that is added to a device to accommodate different capture perspectives can increase the cost of the device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for switchable camera mirror apparatus are described. In one or more embodiments, a computing device (e.g., a tablet device, a smartphone, and so on) includes a camera functionality that is configured to capture images from a variety of different device perspectives. The camera functionality, for instance, can enable images to be captured from a front-facing device perspective, a rear-facing device perspective, and so on. Included as part of the camera functionality is a switchable mirror apparatus that is switchable to alternately reflect light from different device perspectives, such as to enable images to be captured from at least some of the different device perspectives using a single image sensor.

In at least some implementations, a switchable mirror apparatus includes a mirror that is rotatable to enable images to be captured from different device perspectives. For example, the mirror can be rotated to switch from reflecting light from one device perspective, to reflecting light from a different device perspective. Alternatively or additionally, a switchable mirror apparatus can include hingable mirrors that can be repositioned to enable images to be captured from different device perspectives.

In at least some implementations, a switchable mirror apparatus includes portions that can be switched between different light transmission states. For example, varying levels of electrical voltage can be applied to portions of the switchable mirror apparatus to switch the portions from a reflective state to a transparent state, and vice-versa. Switching the mirror apparatus between different light transmission states can enable light to be reflected from different device perspectives such that images can be captured from the different device perspectives.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein.

FIG. 2a depicts an example computing device orientation in accordance with one or more embodiments.

FIG. 2b depicts an example computing device orientation in accordance with one or more embodiments.

FIG. 3 illustrates an example implementation scenario in accordance with one or more embodiments.

FIG. 4 illustrates an example implementation scenario in accordance with one or more embodiments.

FIG. 5 illustrates an example implementation scenario in accordance with one or more embodiments.

FIG. 6 illustrates an example implementation scenario in accordance with one or more embodiments.

FIG. 7 illustrates an example implementation scenario in accordance with one or more embodiments.

FIG. 8 illustrates an example implementation scenario in accordance with one or more embodiments.

FIG. 9 is a flow diagram that describes steps in a method in accordance with one or more embodiments.

FIG. 10 is a flow diagram that describes steps in a method in accordance with one or more embodiments.

FIG. 11 illustrates an example system including various components of an example device that can be implemented as any type of computing device as described with reference to FIGS. 1-10 to implement embodiments of the techniques described herein.

### DETAILED DESCRIPTION

### Overview

Techniques for switchable camera mirror apparatus are described. In one or more embodiments, a computing device (e.g., a tablet device, a smartphone, and so on) includes a camera functionality that is configured to capture images from a variety of different device perspectives. The camera functionality, for instance, can enable images to be captured from a front-facing device perspective, a rear-facing device perspective, and so on. Included as part of the camera functionality is a switchable mirror apparatus that is switchable to alternately reflect light from different device perspectives, such as to enable images to be captured from at least some of the different device perspectives using a single image sensor.

In at least some implementations, a switchable mirror apparatus includes a mirror that is rotatable to enable images to be captured from different device perspectives. For example, the mirror can be rotated to switch from reflecting light from one device perspective, to reflecting light from a different device perspective. Alternatively or additionally, a switchable mirror apparatus can include hingable mirrors that can be repositioned to enable images to be captured from different device perspectives.

In at least some implementations, a switchable mirror apparatus includes portions that can be switched between different light transmission states. For example, varying levels of electrical voltage can be applied to portions of the switchable mirror apparatus to switch the portions from a reflective state to a transparent state, and vice-versa. Switching the mirror apparatus between different light transmission states can enable light to be reflected from different device perspectives such that images can be captured from the different device perspectives.

In the following discussion, an example environment is first described that may employ techniques described herein. Next, a section entitled “Example Implementation Scenarios” describes some example implementations scenarios for implementing techniques discussed herein in accordance with one or more embodiments. Following this, a section entitled “Stereoscopic Implementations” describes some example implementation scenarios for capturing stereoscopic images in accordance with one or more embodiments. Next, a section entitled “Example Procedures” describes some example procedures in accordance with one or more embodiments. The example procedures may be performed in the example environment as well as other environments. Consequently, performance of the example procedures is not limited to the example environment and the example environment is not limited to performance of the example procedures. Finally, an example system and device are described in which embodiments may be implemented in accordance with one or more embodiments.

Example Environment

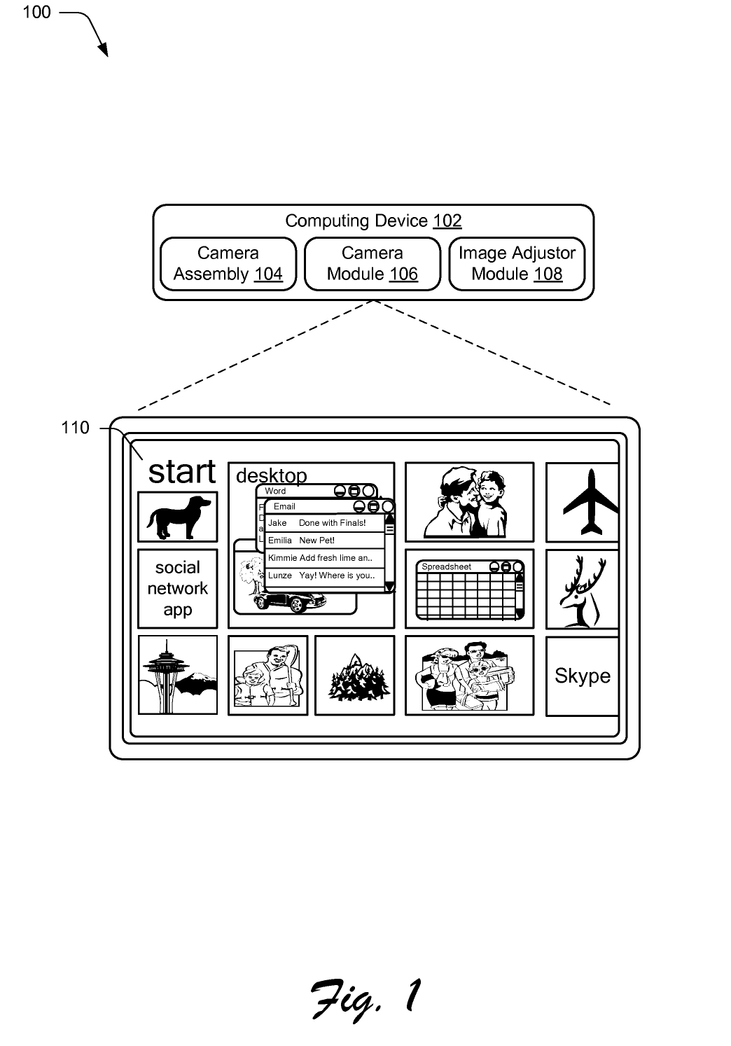

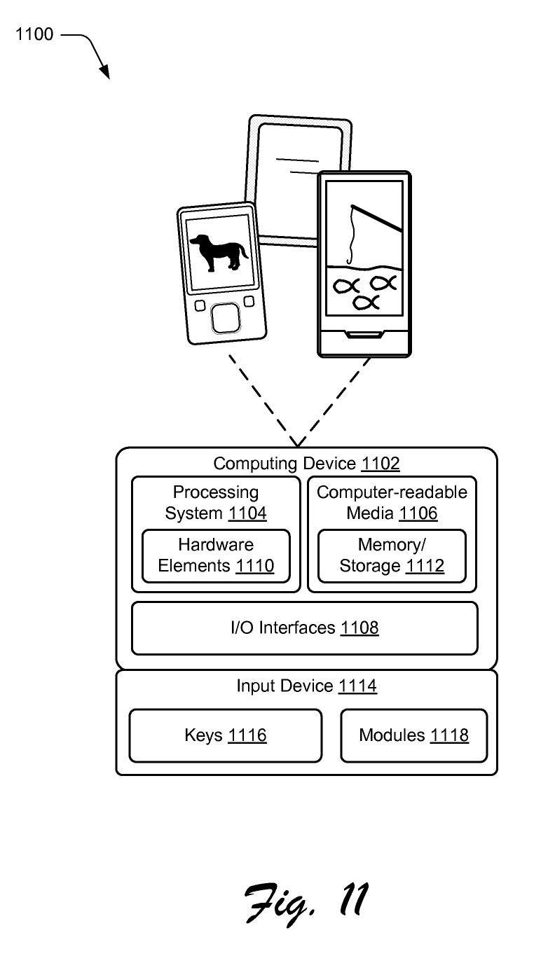

FIG. 1 is an illustration of an environment 100 in an example implementation that is operable to employ techniques described herein. The illustrated environment 100 includes an example of a computing device 102, which may be configured in a variety of ways. For example, the computing device 102 may be configured for mobile use, such as a mobile phone, a tablet computer as illustrated, and so on. Thus, the computing device 102 may range from full resource devices with substantial memory and processor resources to a low-resource device with fewer memory and/or processing resources. Example implementations of the computing device 102 are discussed below with reference to FIG. 11.

The computing device 102 includes a camera assembly 104, which is representative of functionality to record images, such as still images, video, and so on. The camera assembly 104 can include various image capture components, such as apertures, lenses, mirrors, prisms, electronic image sensors, and so on. As discussed in detail herein, the camera assembly 104 includes a switchable mirror apparatus that is configured to be switched between different orientations and/or light transmission states to enable images to be captured from different perspectives of the computing device 102.

The camera assembly 104 can also include structural components employed to mount image capture components into the computing device 102, such as a component carrier in which the image capture components can be installed. The component carrier can enable image capture components of the camera assembly 104 to be securely mounted inside the computing device 102.

The computing device 102 also includes a camera module 106, which is representative of functionality to perform various operations related to techniques for switchable camera mirror apparatus discussed herein. For example, as detailed below, the computing device 102 is configured to capture images from multiple perspectives relative to the computing device 102, such as from a rear-facing perspective, a front-facing perspective, and so on. Thus, as discussed in detail below, the camera module 106 can cause adjustments to be made to various components of the camera assembly 104 to enable images to be captured from the different perspectives.

Further included as part of the computing device 102 is an image adjustor module 108, which is representative of functionality to apply various types of adjustments to image data for the computing device 102. For instance, the image adjustor module 108 can apply color correction to images captured via the computing device 102, such as to compensate for color profile characteristics of the camera assembly 104. The image adjustor module 108 may also perform image manipulation, such image correction to compensate for image distortion, e.g., barrel distortion, pincushion distortion, and so forth. Still further, the image adjustor module 108 may provide light enhancement, such as to compensate for low light scenarios.

The computing device 102 further includes a display device 110, which is configured to display graphical content for the computing device 102. For example, the display device 110 can display images, video, and so on, that are captured via the camera assembly 104.

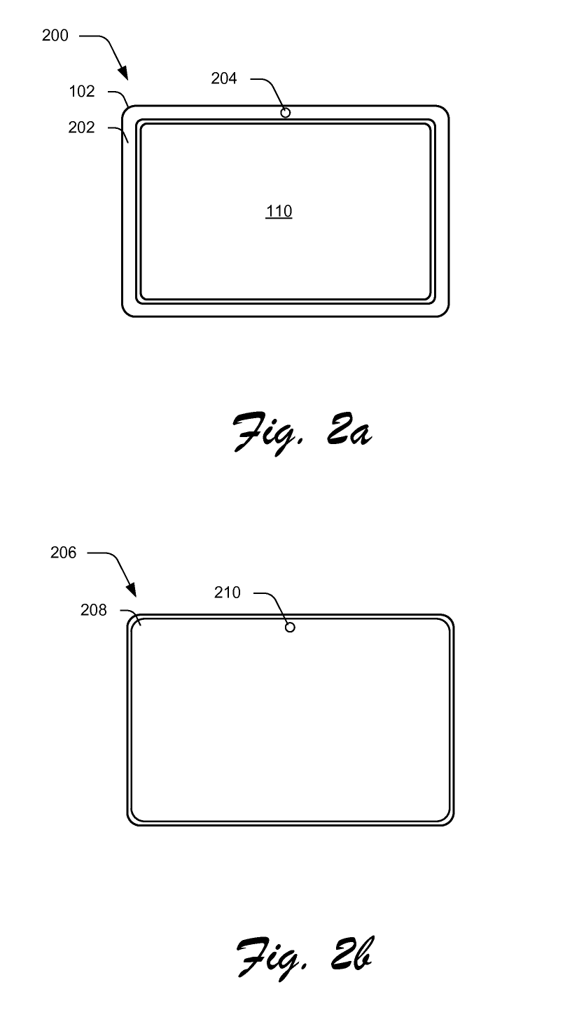

FIG. 2a illustrates a front-facing orientation 200 of the computing device 102, in accordance with one or more embodiments. In the front-facing orientation 200, a front surface 202 of the computing device 102 is visible. Illustrated as part of the front surface 202 is the display device 110 and a front aperture 204. The front aperture 204 is configured to enable light to pass through the front surface 202 and into the camera assembly 104 inside the computing device 102. For instance, the front aperture 204 can enable reflected light from an object external to the computing device 102 to be captured via the camera assembly 104.

While the front aperture 204 is illustrated in the center widthwise of the front surface 202, this is not intended to be limiting on the claimed subject matter. For instance, the front aperture 204 can be placed at any suitable position on the front surface 202. Further, the front surface 202 may include multiple apertures for capturing images from various angles and positions, such as for implementing stereoscopic and/or three-dimensional (3D) image capture.

FIG. 2b illustrates a rear-facing orientation 206 of the computing device 102, in accordance with one or more embodiments. Illustrated as part of the rear-facing orientation 206 is a rear surface 208 of the computing device 102, which includes a rear aperture 210. The rear aperture 210 is configured to enable light to pass through the rear surface 208 and into the camera assembly 104 inside the computing device 102. For instance, the rear aperture 210 can enable reflected light from an object external to the computing device 102 to be captured via the camera assembly 104.

While the rear aperture 210 is illustrated in the center widthwise of the rear surface 208, this is not intended to be limiting on the claimed subject matter. For instance, the rear aperture 210 can be placed at any suitable position on the rear surface 208. Further, the rear surface 208 may include multiple apertures for capturing images from various angles and positions, such as for implementing stereoscopic and/or three-dimensional (3D) image capture.

In at least some implementations, the apertures discussed herein are formed from a transparent material, such as plastic, glass, and so forth. The apertures may also include various types of lenses and/or lens assemblies, such as optical lenses suitable for camera applications.

Having discussed an example environment in which embodiments may operate, consider now some example implementation scenarios in accordance with one or more embodiments.

Example Implementation Scenarios

The following discussion presents some example implementation scenarios in accordance with various embodiments.

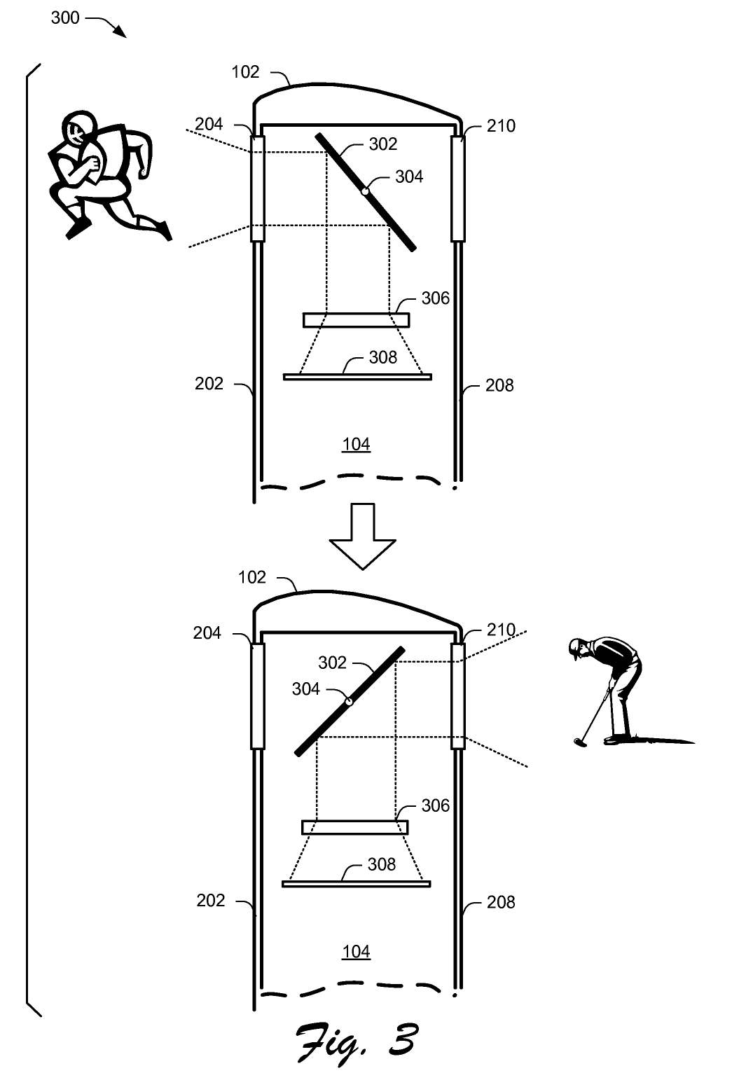

FIG. 3 illustrates an example implementation scenario, generally at 300. In the upper portion of the scenario 300, a cross-section of a side view of the computing device 102 is illustrated. Illustrated as part of the side view are the front surface 202 and the rear surface 208, which include the front aperture 204 and the rear aperture 210, respectively.

Also illustrated is the camera assembly 104, which is positioned internally to the computing device 102 and includes various components for image capture according to embodiments discussed herein. For instance, the camera assembly 104 includes an adjustable mirror 302, which is positionable to reflect light that passes through the front aperture 204 and/or the rear aperture 210.

The adjustable mirror 302 is configured to be physically manipulated between various positions to accommodate different image capture perspectives. For instance, the adjustable mirror 302 can be pivotably adjusted via a pivoting assembly 304 attached to the adjustable mirror 302. The pivoting assembly 304 includes pivoting portions (e.g., spindles) attached to opposite sides of the adjustable mirror 302 such that rotation of the pivoting assembly 304 causes the adjustable mirror 302 to rotate. For example, a motor and/or other mechanism for applying force can be leveraged to rotate the pivoting assembly 304, and thus the adjustable mirror 302.

The camera assembly 104 further includes a lens assembly 306 and a sensor 308. The lens assembly 306 is configured to receive light that is reflected by the adjustable mirror 302, and to focus the light onto the sensor 308. The lens assembly 306 can assume any suitable configuration, including one or multiple lenses. The sensor 308 is configured to convert an optical image into an electronic signal, which can be manipulated to generate image data. For instance, the image data can be utilized to generate a digital image that can be displayed via the display device 110.

As illustrated in the upper portion of the scenario 300, the adjustable mirror 302 is positioned to reflect light that passes through the front aperture 204 onto the lens assembly 306, which then focuses the light on the sensor 308. Thus, the camera assembly 104 can be employed to capture an image of an object that is facing the front surface 202 of the computing device 102. In at least some implementations, when the adjustable mirror 302 is in this position, light that passes through the rear aperture 210 is not reflected onto the lens assembly 306 and/or the sensor 308.

Continuing to the lower portion of the scenario 300, the adjustable mirror 302 is repositioned to reflect light that passes through the rear aperture 210 onto the lens assembly 306, and thus the sensor 308. For instance, the adjustable mirror 302 can be rotated about the pivoting assembly 304 to assume this position. Thus, in this position the camera assembly 104 can be employed to capture an image of an object that is facing the rear surface 208 of the computing device 102. In at least some implementations, when the adjustable mirror 302 is in this position, light that passes through the front aperture 204 is not reflected onto the lens assembly 306 and/or the sensor 308.

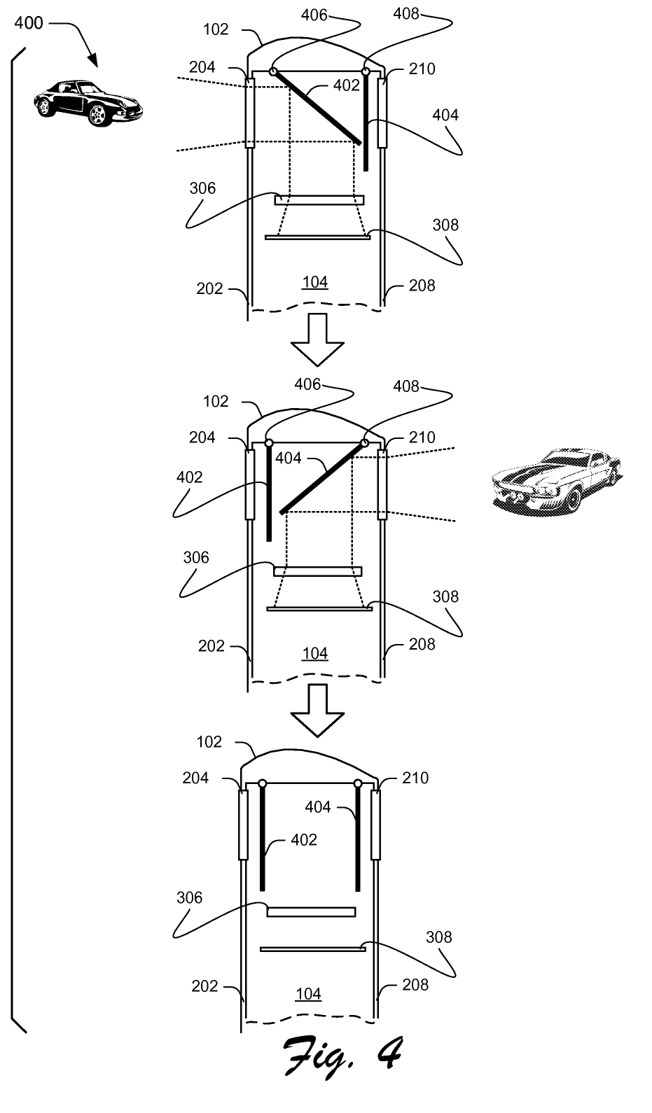

FIG. 4 illustrates another example implementation scenario, generally at 400. In the upper portion of the scenario 400, a cross-section of a side view of the computing device 102 is illustrated. Illustrated as part of the side view are the front surface 202 and the rear surface 208, which include the front aperture 204 and the rear aperture 210, respectively. Also illustrated is the camera assembly 104 with the lens assembly 306 and the sensor 308.

Further to the scenario 400, the camera assembly 104 includes a first adjustable mirror 402 and a second adjustable mirror 404. The first adjustable mirror 402 is attached to an interior portion of the computing device 102 via a first hinge mechanism 406, and the second adjustable mirror 404 is attached to an interior portion of the computing device 102 via a second hinge mechanism 408. The first hinge mechanism 406 is rotatable to enable the first adjustable mirror 402 to be repositioned to different positions, and the second hinge mechanism 408 is rotatable to enable the second adjustable mirror 404 to be repositioned to different positions. For instance, a motor and/or other mechanism for applying force can be used to cause the first hinge mechanism 406 and/or the second hinge mechanism 408 to rotate and thus reposition the first adjustable mirror 402 and/or the second adjustable mirror 404.

In the upper portion of the scenario 400, the first adjustable mirror 402 is positioned to reflect light that passes through the front aperture 204 onto the lens assembly 306, which focuses the light onto the sensor 308. The second adjustable mirror 404 is positioned to block light from passing through the rear aperture 210 onto the lens assembly 306 and the sensor 308. Thus, in this position the camera assembly 104 can be employed to capture an image of an object that is facing the front surface 202 of the computing device 102.

In the center portion of the scenario 400, the first adjustable mirror 402 and the second adjustable mirror 404 are repositioned. For instance, the first adjustable mirror 402 is rotated downward via the first hinge mechanism 406 such that light that passes through the front aperture 204 is blocked from passing onto the lens assembly 306 and the sensor 308. The second adjustable mirror 404 is rotated upward via the second hinge mechanism 408 such that light that passes through the rear aperture 210 is reflected onto the lens assembly 306, which focuses the light onto the sensor 308. Thus, in this position the camera assembly 104 can be employed to capture an image of an object that is facing the rear surface 208 of the computing device 102.

In the lower portion of the scenario 400, the second adjustable mirror 404 is positioned to block light from passing through the rear aperture 210 and onto the lens assembly 306 and the sensor 308. Further, the first adjustable mirror 402 is positioned to block light from passing through the front aperture 204 and onto the lens assembly 306 and the sensor 308. In at least some implementations, this position can correspond to an off position, such as when camera functionality of the computing device 102 is turned off.

Having discussed some embodiments that utilize mechanically adjustable mirrors, consider some embodiments that utilize smart mirrors in accordance with various implementations.

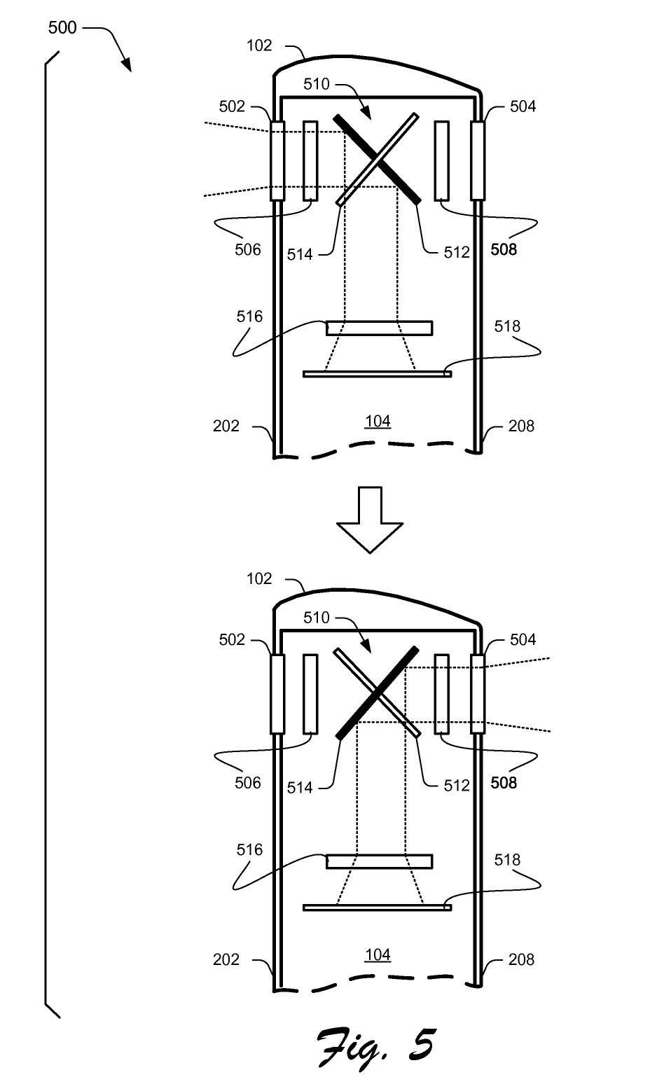

FIG. 5 illustrates an example implementation scenario, generally at 500. In the upper portion of the scenario 500, a cross-section of a side view of the computing device 102 is illustrated. Illustrated as part of the side view are the front surface 202 and the rear surface 208, which include a front aperture 502 and a rear aperture 504, respectively.

Further illustrated is the camera assembly 104, which includes a front lens assembly 506, a rear lens assembly 508, and a smart mirror assembly 510. The front lens assembly 506 and/or the rear lens assembly 508 can include a variety of different types and/or combinations of lenses that can focus light that passes through the respective apertures.

The smart mirror assembly 510 is formed using one or more types of optically switchable materials to enable the smart mirror assembly 510 to be switched between different light transmission states. For example, at least some portions of the smart mirror assembly 510 can be switched from a reflective state that reflects incident light (e.g., a mirror) to a transparent state that allows incident light to pass through. The smart mirror assembly 510, for instance, can change between light transmission states in response to electrical voltage being applied to the smart mirror assembly. For example, the smart mirror assembly 510 can be electrically and/or communicatively connected to a functionality of the computing device 102 that can control electrical current that is applied to the smart mirror assembly 510. One example of such a functionality is the camera module 106.

Controlling electrical current applied to the smart mirror assembly 510 can cause portions of the smart mirror assembly 510 to switch between different light transmission states. Examples of optically switchable materials that can be used to form the smart mirror assembly 510 include electrochromic materials (e.g., electrochromic glass), suspended particle devices (e.g., thin film laminates, switchable films, and so on), liquid crystal devices (LCDs), and so on.

In the upper portion of the scenario 500, the computing device 102 is in a front-facing mode in which the camera assembly 104 is configured to capture an image of an object that is facing the front surface 202 of the computing device 102. For instance, a portion 512 of the smart mirror assembly 510 is in a reflective mode such that light that passes through the front aperture 502 and the front lens assembly 506 is reflected by the portion 512. Further, a portion 514 of the smart mirror assembly 510 is in a transparent mode such that light that is reflected by the portion 512 passes through the portion 514. Thus, the portion 512 and the portion 514 of the smart mirror assembly 510 can be separately switchable such one of the portions can be switched into a different light transmission mode than another of the portions.

In the illustrated implementation, light that is reflected by the portion 512 can pass through the portion 514 and onto a central lens assembly 516. The central lens assembly 516 can include one or more lenses, and can focus the reflected light onto a sensor 518 to enable an image to be captured.

Proceeding to the lower portion of the scenario 500, the computing device 102 is switched to a rear-facing mode in which the camera assembly 104 is configured to capture an image of an object that is facing the rear surface 208 of the computing device 102. For instance, the portion 514 of the smart mirror assembly 510 is switched to a reflective mode such that light that passes through the rear aperture 504 and the rear lens assembly 508 is reflected by the portion 514. Further, the portion 512 is switched to a transparent mode such that light that is reflected by the portion 514 passes through the portion 512 and onto the central lens assembly 516. The central lens assembly 516 can focus the reflected light onto the sensor 518 to enable an image to be captured.

In at least some implementations, the camera assembly 104 can be switched to an “off” mode in which camera functionality of the computing device 102 is turned off For example, the smart mirror assembly 510 (e.g., the portion 512 and the portion 514) can be switched to a reflective mode such that light that passes through the front aperture 502 and/or the rear aperture 504 is not transmitted to the central lens assembly 516 or the sensor 518.

In at least some implementations, image correction can be applied to a captured image to adjust various attributes of the image. For example, light reflection properties of the smart mirror assembly 510 may be such that certain wavelengths of light (e.g., colors) are reflected at a different intensity than other wavelengths. Thus, color correction can be applied (e.g., by the image adjustor module 108) to balance the color profile of an image, such as to better match the actual color of a photographed object.

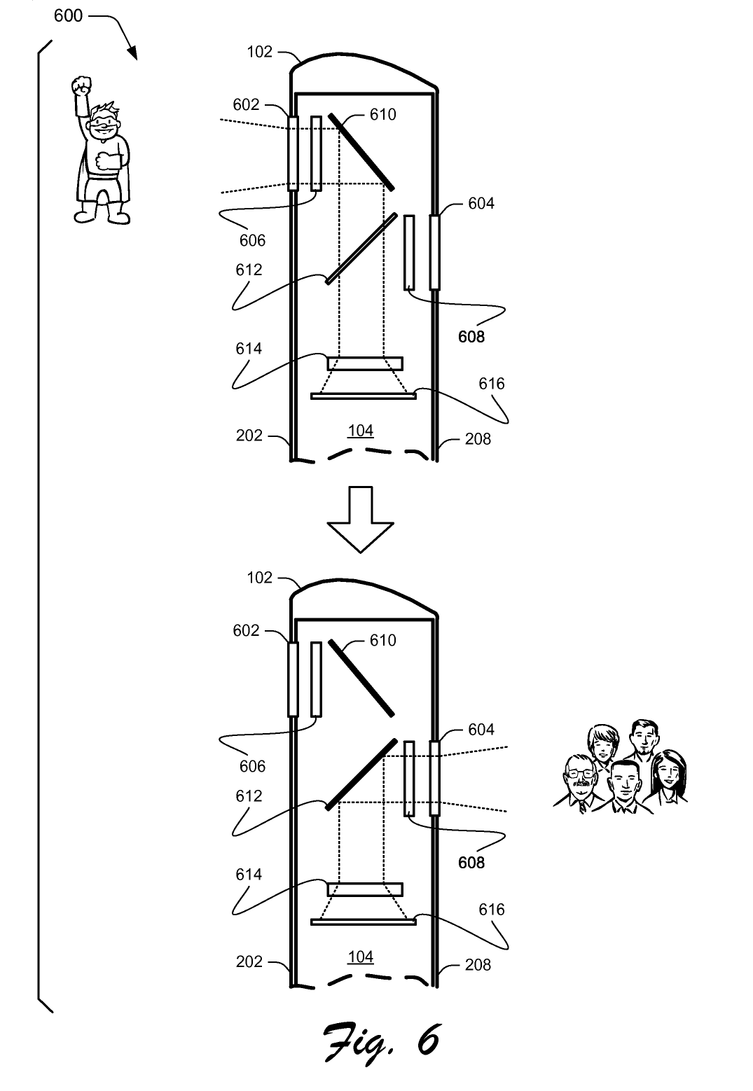

FIG. 6 illustrates another example implementation scenario, generally at 600. In the upper portion of the scenario 600, a side view of a cross-section of the computing device 102 is illustrated. Illustrated as part of the side view are the front surface 202 and the rear surface 208, which include a front aperture 602 and a rear aperture 604, respectively.

Further illustrated is the camera assembly 104, which includes a front lens assembly 606, a rear lens assembly 608, a mirror 610, and a smart mirror 612. In at least some implementations, the mirror 610 can be formed from a standard reflective material, such as mirrored glass, metal, coated polymer, and so on. Alternatively, the mirror 610 can be configured from an optically switchable material (e.g., as a smart mirror), examples of which are discussed herein.

The smart mirror 612 is formed from one or more types of optically switchable materials to enable the smart mirror 612 to be switched between different light transmission states. Examples of suitable optically switchable materials are given above. Further, the smart mirror 612 can be electrically and/or communicatively connected to a functionality of the computing device 102 (e.g., the camera module 106) that can control light transmission state of the smart mirror 612, such as by controlling electrical signal (could be current or voltage) that is applied to the smart mirror 612.

In the upper portion of the scenario 600, the computing device 102 is in a front-facing mode in which the camera assembly 104 is configured to capture an image of an object that is facing the front surface 202 of the computing device 102. The mirror 610, for instance, reflects light that passes through the front aperture 602 and the front lens assembly 606. Further, the smart mirror 612 is in a transparent mode such that light that is reflected from the mirror 610 passes through the smart mirror 612 and onto a central lens assembly 614. The central lens assembly 614 focuses the light onto a sensor 616 to enable an image from a front perspective of the computing device 102 to be captured.

Further to the front-facing mode, light that passes through the rear aperture 604 and the rear lens assembly 608 is not reflected onto the central lens assembly 614 and the sensor 616. For instance, light that passes through the rear aperture 604 and the rear lens assembly 608 may also pass through the smart mirror 612 and be absorbed by other internal surfaces of the computing device 102.

Proceeding to the lower portion of the scenario 600, the computing device 102 is switched to a rear-facing mode in which the camera assembly 104 is configured to capture an image of an object that is facing the rear surface 208 of the computing device 102. In the rear-facing mode, the smart mirror 612 is switched to a reflective mode such that light that passes through the rear aperture 604 and the rear lens assembly 608 is reflected onto the central lens assembly 614. The central lens assembly 614 focuses the light onto the sensor 616 to enable an image from a rear perspective of the computing device 102 to be captured.

In the rear-facing mode, the sensor 616 can be shielded from light that is incident on the front surface 202. For example, light that passes through the front aperture 602 and the front lens assembly 606 can be reflected off of a back surface of the smart mirror 612 such that the light is not transmitted to the central lens assembly 614 and the sensor 616.

Thus, as illustrated in the scenarios 500 and 600, embodiments can utilize optically switchable materials to enable a single sensor to be used to capture images from a variety of different device perspectives and orientations.

Having discussed some example implementation scenarios, consider now a discussion of some example stereoscopic implementations in accordance with one or more embodiments.

Stereoscopic Implementations

Embodiments can be employed to enable stereoscopic images to be captured, such as 2-dimensional (2D) images that give the visual appearance of 3-dimensional (3D) images. For example, consider the following implementation scenarios.

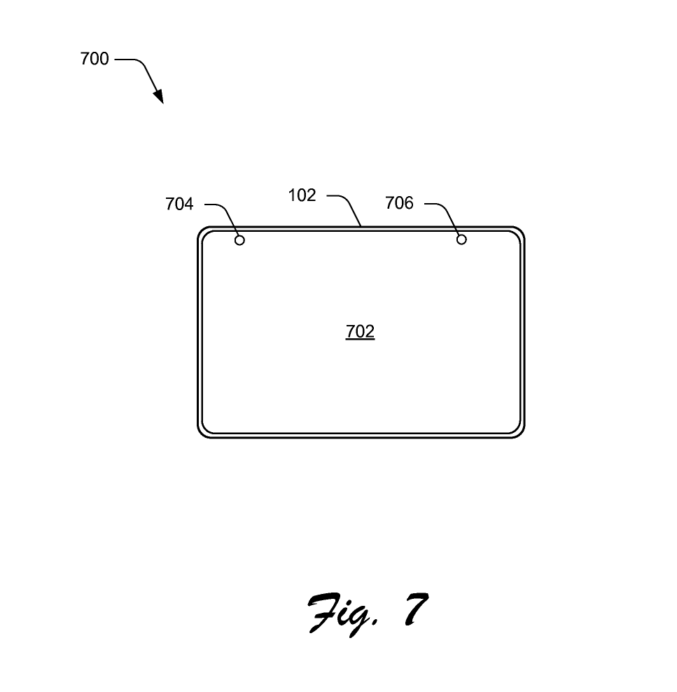

FIG. 7 illustrates an example implementation scenario, generally at 700. In the scenario 700, the computing device 102 is configured to capture stereoscopic images, such as for 3-dimensional (3D) photography. Illustrated as part of the scenario 700 is a rear surface 702 of the computing device 102, which includes a first rear aperture 704 and a second rear aperture 706. As illustrated in the following implementation scenario, the first rear aperture 704 and the second rear aperture 706 can be employed to receive light into the computing device 102 for capturing stereoscopic images.

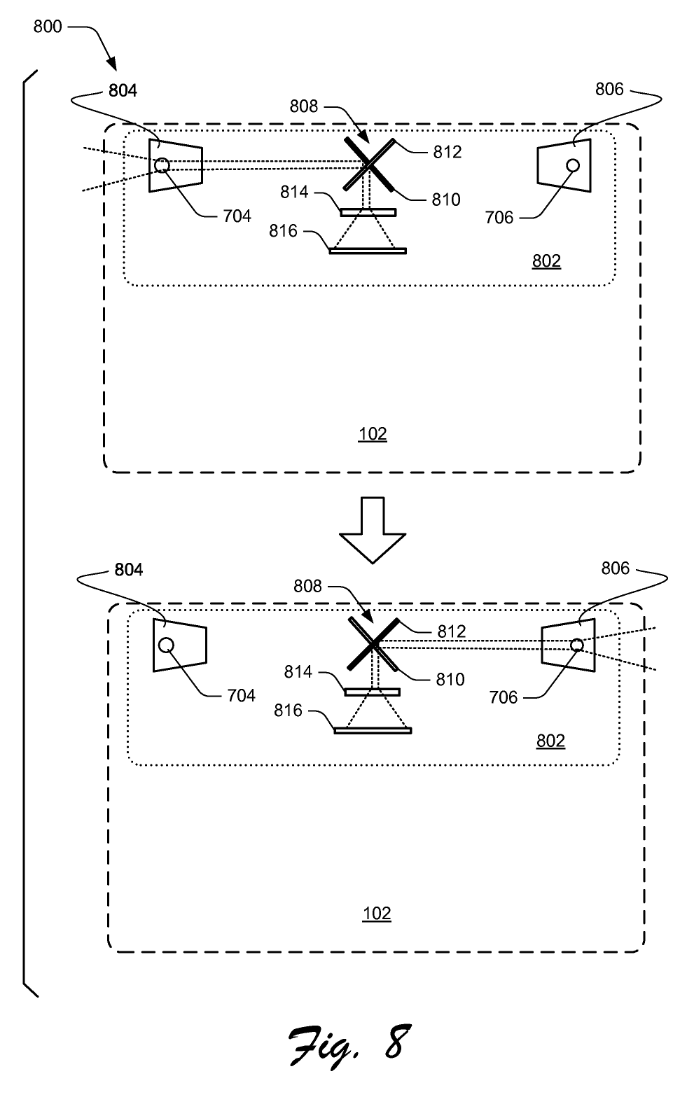

FIG. 8 illustrates an example implementation scenario for capturing a stereoscopic image, generally at 800. In the scenario 800, a cutaway of a rear view of the computing device 102 is illustrated. Further illustrated are the first rear aperture 704, the second rear aperture 706, and a camera assembly 802 which is attached internally to the computing device 102.

The camera assembly 802 includes a first mirror 804, a second mirror 806, and a smart mirror assembly 808. In at least some implementations, the first mirror 804 and/or the second mirror 806 can be formed from a standard reflective material, such as mirrored glass, metal, coated polymer, and so on. Alternatively, the first mirror 804 and/or the second mirror 806 can be configured from an optically switchable material (e.g., as a smart mirror), examples of which are discussed herein. The smart mirror assembly 808 is formed from an optically switchable material, examples of which are discussed above. Although not expressly illustrated here, a variety of different lens assemblies can be incorporated, such as between the first rear aperture 704 and the first mirror 804, between the second rear aperture 706 and the second mirror 806, and so on.

In the upper portion of the scenario 800, an image is captured via the first rear aperture 704. The image can be captured, for example, in response to a user activation of a camera functionality of the computing device 102. Further to the image capture, a portion 810 of the smart mirror assembly 808 is in a reflective state and a portion 812 of the smart mirror assembly 808 is in a transparent state. Thus, light that passes through the first rear aperture 704 is reflected by the first mirror 804 onto the portion 810, which reflects the light through the portion 812 and onto a central lens assembly 814. The central lens assembly 814 focuses the light onto a sensor 816 to enable an image to be captured. Further, light that passes through the second rear aperture 706 and that is reflected by the second mirror 806 onto the portion 810 is reflected away from the central lens assembly 814 and the sensor 816.

Proceeding to the lower portion of the scenario 800, an image is captured via the second rear aperture 706. For instance, the portion 812 of the smart mirror assembly 808 is switched to a reflective state. Further, the portion 810 of the smart mirror assembly 808 is switched to a transparent state. Thus, light that passes through the second rear aperture 706 is reflected by the second mirror 806 onto the portion 812, which reflects the light through the portion 810 and onto the central lens assembly 814. The central lens assembly 814 focuses the light onto the sensor 816 to enable an image to be captured. Further, light that passes through the first rear aperture 704 and that is reflected by the first mirror 804 onto the portion 812 is reflected away from the central lens assembly 814 and the sensor 816.

In at least some implementations, functionality of the computing device 102 (e.g., the camera module 106) can switch portions of the smart mirror assembly 808 between various light transmission states, as discussed elsewhere herein. Further, the portion 810 and the portion 812 of the smart mirror assembly 808 can be separately switchable such that one of the portions can be switched into a different light transmission state than another of the portions. For example, the portion 810 and the portion 812 can be sequentially switched to enable a first image to be captured via the first rear aperture 704, and then a second image to be captured via the second rear aperture 706. The images, for instance, can be automatically captured in response to a single user activation of a camera functionality of the computing device 102. The first image and the second image can be overlaid to produce a stereoscopic image. Thus, light transmission state of various portions of the computing device 102 (e.g., the smart mirror assembly 808) can be tailored to suit a variety of different image capture and/or camera mode scenarios, including capture of still images, video recording, and so forth.

Further, although the scenario 800 is discussed with reference to electrically switchable mirrors (e.g., the smart mirror assembly 808), at least some embodiments may alternatively or additionally utilize physically movable mirrors that can be physically adjusted to reflect light accordingly to different reflection paths to capture a stereoscopic image.

The example computing device configurations discussed above are presented for purpose of example only, and techniques discussed herein can be implemented to enable images to be captured in a wide variety of different device configurations. Further, although the camera assembly 104 is illustrated in a particular position and orientation with reference to the computing device 102, this is not intended to be limiting. The camera assembly 104, for instance, can be oriented in a wide variety of different positions on the computing device 102 within the spirit and scope of the claimed embodiments. The orientations and configurations of the mirrors and/or mirror assemblies discussed above are presented for purpose of example only, and embodiments can employ a wide variety of different mirror configurations and orientations within the spirit and scope of the claimed embodiments.

Having discussed some example stereoscopic implementations, consider now some example procedures in accordance with one or more embodiments.

Example Procedures

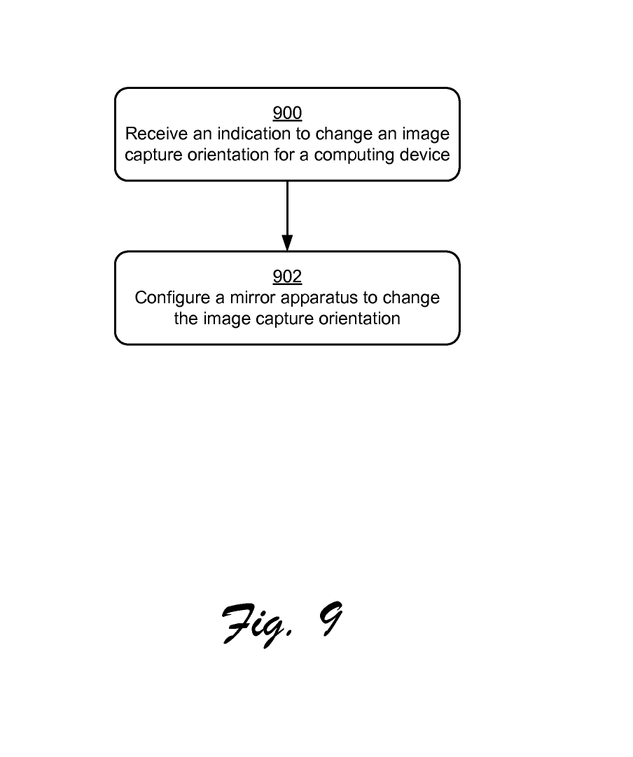

FIG. 9 is a flow diagram that describes steps in a method in accordance with one or more embodiments. In at least some embodiments, the method can be employed to enable images to be captured from a variety of different device perspectives.

Step 900 receives an indication to change an image capture orientation for a computing device. The indication, for example, can be received based on user input to the computing device 102 to select a camera orientation. For instance, a user can provide input to change from a front-facing camera to a rear-facing camera, and vice-versa. A variety of other camera orientations may be employed in accordance with the claimed embodiments.

Step 902 configures a mirror apparatus to change the image capture orientation. For example, one or more mirrors can be physically manipulated, such as discussed above with reference to the scenarios 300 and 400. Additionally or alternatively, one or more mirrors (e.g., a smart mirror) can be electrically switched between light transmission states, such as discussed above with reference to the scenarios 500 and 600. In at least some implementations, a mirror apparatus can be manipulable to enable images to be captured from multiple computing device perspectives and using a single image sensor.

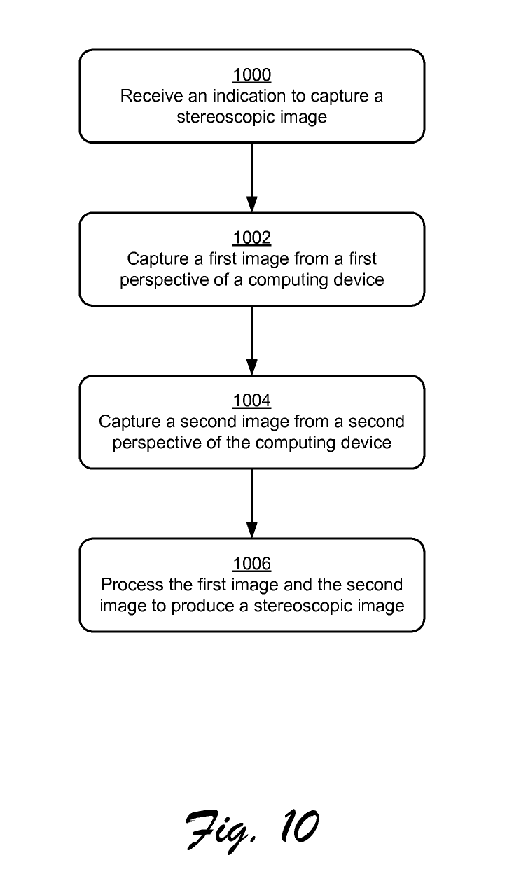

FIG. 10 is a flow diagram that describes steps in a method in accordance with one or more embodiments. In at least some embodiments, the method can be employed to enable a stereoscopic image to be captured.

Step 1000 receives an indication to capture a stereoscopic image. The indication, for instance, can be received in response to a user activation of an image capture functionality of a computing device. Step 1002 captures a first image from a first perspective of a computing device. For example, with reference to the scenario 800 discussed above, an image can be captured via the first rear aperture 704 of the computing device 102.

Step 1004 captures a second image from a second perspective of the computing device. With reference to the scenario 800 discussed above, for example, an image can be captured via the second rear aperture 706 of the computing device 102. Capturing an image from the second perspective can involve reconfiguring a mirror apparatus of a camera functionality, such as physically manipulating a mirror apparatus, electrically switching a mirror apparatus (e.g., a smart mirror), and so on.

In at least some implementations, the first image and the second image can be captured automatically and/or sequentially, such as in response to a single user input. A preset time delay may also be implemented between the capture of the first image and the second image, such as 500 milliseconds, 1 second, and so on. The time delay, for instance, can enable the first image to be saved to memory and a mirror apparatus to be reconfigured such that light can be transmitted from the second perspective.

Step 1006 processes the first image and the second image to produce a stereoscopic image. For instance, the first image and the second image can be overlaid to produce the stereoscopic image.

Having discussed some example procedures, consider now an example system and device in accordance with one or more embodiments.

Example System and Device

FIG. 11 illustrates an example system generally at 1100 that includes an example computing device 1102 that is representative of one or more computing systems and/or devices that may implement the various techniques described herein. The computing device 1102 may be, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 1102 as illustrated includes a processing system 1104, one or more computer-readable media 1106, and one or more I/O interface 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1106 is illustrated as including memory/storage 1112. The memory/storage 1112 represents memory/storage capacity associated with one or more computer-readable media. The memory/storage component 1112 may include volatile media (such as random access memory (RAM)) and/or nonvolatile media (such as read only memory (ROM), Flash memory, optical disks, magnetic disks, and so forth). The memory/storage component 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone (e.g., for voice and/or audio input), a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways to support user interaction.

The computing device 1102 is further illustrated as being communicatively and physically coupled to an input device 1114 that is physically and communicatively removable from the computing device 1102. In this way, a variety of different input devices may be coupled to the computing device 1102 having a wide variety of configurations to support a wide variety of functionality. In this example, the input device 1114 includes one or more keys 1116, which may be configured as pressure sensitive keys, mechanically switched keys, and so forth.

The input device 1114 is further illustrated as include one or more modules 1118 that may be configured to support a variety of functionality. The one or more modules 1118, for instance, may be configured to process analog and/or digital signals received from the keys 1116 to determine whether a keystroke was intended, determine whether an input is indicative of resting pressure, support authentication of the input device 1114 for operation with the computing device 1102, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof The features of the techniques described herein are platform-independent, meaning that the techniques may be implemented on a variety of commercial computing platforms having a variety of processors.

Techniques may further be implemented in a network environment, such as utilizing various cloud-based resources. For instance, methods, procedures, and so forth discussed above may leverage network resources to enable various functionalities.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media excludes transitory signal-bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

Discussed herein are a number of methods that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. An apparatus comprising:
a computing device including a first external surface and a second external surface;
a first aperture disposed on the first external surface, and a second aperture disposed on the second external surface; and
a camera assembly positioned internally to the computing device and including a mirror apparatus that is configurable to alternate between reflecting light received via the first aperture, and reflecting light received via the second aperture, to enable images to be captured from a perspective of the first external surface and a perspective of the second external surface using a single image sensor, the mirror apparatus including:
a first adjustable mirror that is adjustable to reflect light received via the first aperture onto the image sensor; and
a second adjustable mirror that is adjustable independently of the first adjustable mirror to reflect light received via the second aperture onto the image sensor, the mirror apparatus configured such that adjustment of the first adjustable mirror to reflect light received via the first aperture onto the image sensor causes adjustment of the second adjustable mirror to block light from being reflected from the second aperture onto the image sensor.

2. An apparatus as described in claim 1, wherein the first external surface comprises a front surface of the computing device, and the second external surface comprises a rear surface of the computing device.

3. An apparatus as described in claim 1, wherein in an event that the camera functionality of the computing device is in an off mode, the mirror apparatus is configured such that the first adjustable mirror is adjusted to block light from being reflected from the first aperture onto the image sensor and the second adjustable mirror is adjusted to block light from being reflected from the second aperture onto the image sensor.

4. An apparatus as described in claim 1, wherein the first adjustable mirror is attached to an interior portion of the computing device via a first hinge mechanism and the second adjustable mirror is attached to an interior portion of the computing device via a second hinge mechanism.

5. An apparatus as described in claim 1, wherein the apparatus further comprises an image adjustor module, and wherein the image sensor is configured to convert the images into an electronic signal to create image data which is editable by an image adjustor module of the computing device.

6. A camera assembly configured to be mounted internally to a computing device, the camera assembly comprising:
a mirror apparatus that is switchable to alternately reflect light from different perspectives of the computing device; and
an image sensor that is configured to receive light that is reflected by the mirror apparatus from the different perspectives such that images are capturable by the image sensor from the different perspectives, the mirror apparatus including:
a first adjustable mirror that is adjustable to reflect light received via a first aperture of the computing device onto the image sensor; and
a second adjustable mirror that is adjustable independently of the first adjustable mirror to reflect light received via a second aperture of the computing device onto the image sensor, the mirror apparatus configured such that adjustment of the first adjustable mirror to reflect light received via the first aperture onto the image sensor causes adjustment of the second adjustable mirror to block light from being reflected from the second aperture onto the image sensor.

7. A camera assembly as described in claim 6, wherein in an event that the camera functionality of the computing device is in an off mode, the mirror apparatus is configured such that the first adjustable mirror is adjusted to block light from being reflected from the first aperture onto the image sensor and the second adjustable mirror is adjusted to block light from being reflected from the second aperture onto the image sensor.

8. A camera assembly as described in claim 6, wherein the first adjustable mirror is attachable to an interior portion of the computing device via a first hinge mechanism and the second adjustable mirror is attachable to an interior portion of the computing device via a second hinge mechanism.

9. A camera assembly as described in claim 6, wherein the first adjustable mirror is configured to be disposed to reflect light received via the first aperture in a first external surface of the computing device, and the second adjustable mirror is configured to be disposed to reflect light received via the second aperture in a second external surface of the computing device.

10. A camera assembly as described in claim 6, wherein the first adjustable mirror is configured to be disposed to reflect light received via the first aperture in a front surface of the computing device, and the second adjustable mirror is configured to be disposed to reflect light received via the second aperture in a rear surface of the computing device.

11. A camera assembly as described in claim 6, wherein the image sensor is configurable to convert the images into an electronic signal to create image data which is editable by an image adjustor module of the computing device.

12. A computer implemented method comprising:
receiving an indication to change a camera assembly of a computing device from a first image capture orientation to a second image capture orientation; and
configuring a mirror apparatus of the camera assembly responsive to said receiving to switch from the first image capture orientation to the second image capture orientation to enable an image to be captured from the second image capture orientation, said configuring including:
adjusting a first mirror to cause the first mirror to block light received via a first aperture of the computing device from being reflected onto an image sensor of the computing device; and
adjusting a second mirror independently of the first mirror to reflect light received via a second aperture of the computing device onto the image sensor of the computing device to enable an image to be captured in the second image capture orientation.

13. A computer implemented method as recited in claim 12, wherein said receiving an indication to change a camera assembly of a computing device comprises receiving user input to change a camera orientation of the computing device.

14. A computer implemented method as recited in claim 12, wherein said adjusting the first mirror comprises causing the first mirror to pivot about a first hinge, and wherein said adjusting the second mirror comprises causing the second mirror to pivot about a second hinge.

15. A computer implemented method as recited in claim 12, wherein the first image capture orientation comprises one of a front-facing camera orientation or a rear-facing camera orientation, and wherein the second image capture orientation comprises the other one of the front-facing camera orientation or the rear-facing camera orientation.

16. A computer implemented method as recited in claim 12, wherein the mirror apparatus is configurable to enable images to be captured from the first image capture orientation and the second image capture orientation via a single image sensor.

17. A computer implemented method as recited in claim 12, wherein the first mirror is attachable to an interior portion of the computing device via a first hinge and the second mirror is attachable to an interior portion of the computing device via a second hinge.

18. A computer implemented method as recited in claim 12, wherein the mirror apparatus is part of camera functionality of the computing device, and wherein the method further comprises causing the camera apparatus to transition to an off mode including:
adjusting the first mirror to block light from being reflected from the first aperture of the computing device onto the image sensor; and
adjusting the second mirror to block light from being reflected from the second aperture of the computing device onto the image sensor.

19. A computer implemented method as recited in claim 12, wherein the mirror apparatus is part of a camera functionality of the computing device, and wherein the method further comprises:
capturing an image via the camera functionality;
converting, by the image sensor, the image into an electronic signal to create image data which is editable by an image adjustor module of the computing device.

20. A computer implemented method as recited in claim 12, further comprising:
receiving an indication to change the camera assembly of the computing device from the second image capture orientation to the first image capture orientation; and
configuring the mirror apparatus of the camera assembly responsive to said receiving to switch from the second image capture orientation to the first image capture orientation to enable an image to be captured from the first image capture orientation, said configuring including:
adjusting the first mirror to reflect light received via the first aperture onto the image sensor of the computing device to enable an image to be captured in the first image orientation; and
adjusting the second mirror independently of the first mirror to cause the second mirror to block light received via the second aperture from being reflected onto the image sensor of the computing device.
